(19) United States
(12) Patent Application Publication
(10) Pub. No.: US 2008/0256960 A1
(43) Pub. Date: Oct. 23, 2008

(54) Vehicles incorporating tanks for carrying cryogenic fluids and methods for forming such tanks

(76) Inventors: Jeffrey K. Greason, Tehachapi, CA (US); Daniel L. Delong, Mojave, CA (US); Olivier Forget, Mojave, CA (US)

Correspondence Address: CHRISTIE, PARKER & HALE, LLP, PO BOX 7068, PASADENA, CA, 91109-7068, US

(21) Appl. No.: 12/157,833

(22) Filed: Jun. 13, 2008

Related U.S. Application Data
(63) Continuation of application No. 10/866,368, filed on Jun. 11, 2004.

(51) Int. Cl. F17C 3/04; F17C 13/00

(52) U.S. Cl. 62/53.2; 220/560.11; 220/560.07

(57) ABSTRACT

A tank for carrying cryogenic fluids and/or hydrogen peroxide and a method of forming the same is provided. A vehicle incorporating such a tank as part of the vehicle structure is also provided. The tank includes an inner wall compatible with the fluid to be carried, an outer wall, and a spacing layer sandwiched between the two walls. In an exemplary embodiment, the outer wall forms part of the structure of a flight vehicle.

### CROSS-REFERENCE TO RELATED APPLICATION(S)

This application is a continuation of U.S. application Ser. No. 10/866,368, filed on Jun. 11, 2004, the contents of all of which are fully incorporated herein by reference.

### BACKGROUND OF THE INVENTION

The present invention relates to tanks for storing cryogenic fluids and more specifically to tanks having a sandwich construction for storing a cryogenic fluid, to vehicles incorporating such tanks, and to methods for forming such tanks.

Cryogenic tanks, i.e., tanks that carry or store cryogenic or chilled (referred to hereinafter collectively or individually as “cryogenic”) fluids are subject to significant contraction due to the temperature of the cryogenic fluids which could be in the range of about 18° K. to about 240° K. Cryogenic tanks are typically used in aerospace vehicles to carry various cryogenic fluids such as rocket propellant oxidizers and fuels. For example, cryogenic tanks are used on launch vehicles, upper stage launch vehicles, orbit maneuvering vehicles and satellites. In many such applications, the cryogenic tanks are also high pressure tanks as they are sometimes exposed to pressures as high as 800 psia.

Conventional cryogenic tanks shrink substantially when loaded with cryogenic fluid and must have insulation placed between the tank and the vehicle structure to protect the vehicle structure from the low temperatures. Aerospace vehicles, for example, often use liquid oxygen, i.e., a cryogenic fluid as oxidizer. To store liquid oxygen, conventional tanks are suspended within the aerospace vehicle structure to allow contraction of the tank as the temperature of the tank is reduced due to the cryogenic fluid.

To minimize shrinkage, carbon fiber reinforced plastic tanks have been used which exhibit a low coefficient of thermal expansion. Unfortunately, carbon fiber reinforced plastics are not chemically compatible with conventional rocket propellant oxidizers, which are used in aerospace applications as they are flammable. Consequently, close contact of carbon fiber reinforced plastics with oxidizers poses a handling hazard. Furthermore, carbon fiber reinforced plastics become very brittle at cryogenic temperatures and are prone to micro-cracking when cryogenically and pressure cycled.

### SUMMARY OF THE INVENTION

Tanks for carrying cryogenic fluids and/or hydrogen peroxide and methods for forming the same are provided. Flight vehicles incorporating such tanks as part of their structures are also provided.

In one exemplary embodiment a tank for carrying cryogenic fluids is provided. The tank includes an inner wall compatible with the cryogenic fluid to be carried, an outer wall, and an insulating layer sandwiched between the two walls. In another exemplary embodiment, the inner wall is formed from glass fiber reinforced fluoropolymer. In another exemplary embodiment, the inner wall is formed from an iron-nickel alloy. In yet a further exemplary embodiment, a flexible epoxy adhesive is used to bond the insulating layer to the inner wall. In other exemplary embodiments an adhesive having a maximum elongation at the tank operating temperatures of not less than about 1% and/or microballoons may be used. This adhesive may be a cryogen-compatible urethane adhesive. In other exemplary embodiments, the insulating layer has a modulus of elasticity lower than a modulus of elasticity of the inner wall. In yet a further exemplary embodiment, the tank is formed on a flight vehicle and the tank outer wall forms part of vehicle structure. In another exemplary embodiment a fluid is included within the tank selected from the group of fluids consisting of liquid oxygen, hydrogen peroxide, nitrous oxide and liquid methane.

In another exemplary embodiment a tank for carrying cryogenic fluids is provided having an inner wall compatible with the cryogenic fluid to be carried, an outer wall, and an insulating layer having a foamed polymer having a thermal conductivity no greater than about 0.25 Watt/meter-° K. sandwiched between the two walls, and a flexible epoxy adhesive bonding the inner wall to the insulating layer and forming a seal around the inner wall. In one exemplary embodiment the inner wall is formed from glass fiber reinforced fluoropolymer. In a further exemplary embodiment, the tank forms part of a vehicle structure. In yet a further exemplary embodiment the tank carries a fluid selected from the group of fluids consisting of liquid oxygen, hydrogen peroxide, and nitrous oxide.

In yet a further exemplary embodiment a tank for carrying hydrogen peroxide is provided. The tank has an inner wall compatible with hydrogen peroxide, an outer wall, and a spacer sandwiched between the two walls. In one exemplary embodiment the inner wall is formed from a glass fiber reinforced fluoropolymer. In yet a further exemplary embodiment the tank forms part of a vehicle structure.

In another exemplary embodiment a method for forming a tank carrying a fluid is provided. The method includes forming an inner wall, forming an insulating layer over the inner wall, forming an outer wall over the insulating layer, and placing a fluid selected from the group of fluids consisting of cryogenic fluids and hydrogen peroxide within the inner wall of the tank. In one exemplary embodiment forming an inner wall includes forming a glass fiber reinforced fluoropolymer resin over a mandrel. In another exemplary embodiment, forming an inner wall includes forming an inner wall from a iron-nickel alloy.

### BRIEF DESCRIPTION OF THE DRAWINGS

FIG. 1 is a perspective view of an exemplary tank of the present invention.

FIG. 2 is a partial perspective cross-sectional view of an exemplary embodiment tank wall.

FIG. 3 is a perspective schematic view of a flight vehicle having an integrated tank of the present invention.

### DETAILED DESCRIPTION OF THE INVENTION

The present invention relates to tanks for chilled or cryogenic fluids, to vehicles incorporating such tanks and to methods of forming such tanks.

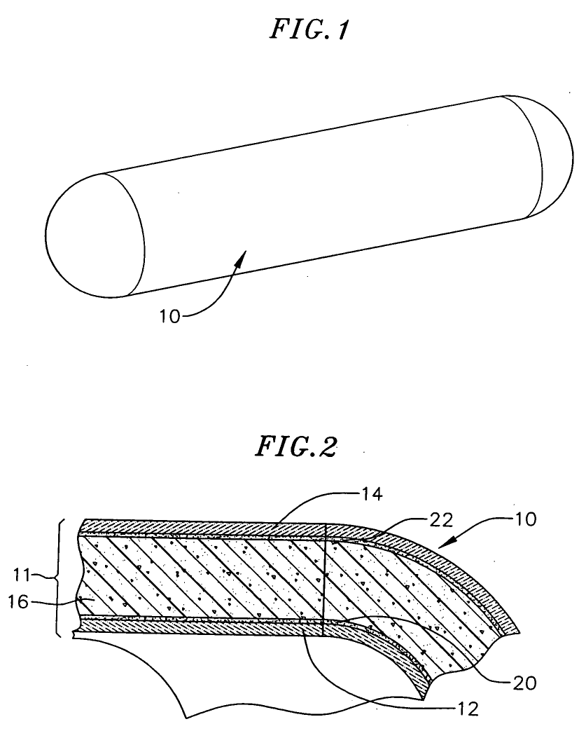

The present invention provides sandwich construction tanks for carrying cryogenic fluids, as for example shown in FIGS. 1 and 2, such as oxidizers, liquid hydrogen and liquid methane, as well as non-cryogenic fluids such as hydrogen peroxide. It should be noted that the figures are not to scale and are used only for illustrative purposes. In an exemplary embodiment shown in FIGS. 1 and 2, a cryogenic tank 10 is defined by a structural wall 11 which when viewed in cross-section includes an inner wall 12 separated from an outer wall 14 by an insulating material forming a core 16. By employing a sandwich construction, the tank inner wall and thus, the tank contents are insulated, and the tank inner wall 12 and outer wall 14 act together to form a rigid structural wall 11. The outer tank wall 14 is thermally isolated from the tank contents by the insulating material core 16 and as such does not suffer from thermal expansion or contraction when the tank contents are loaded.

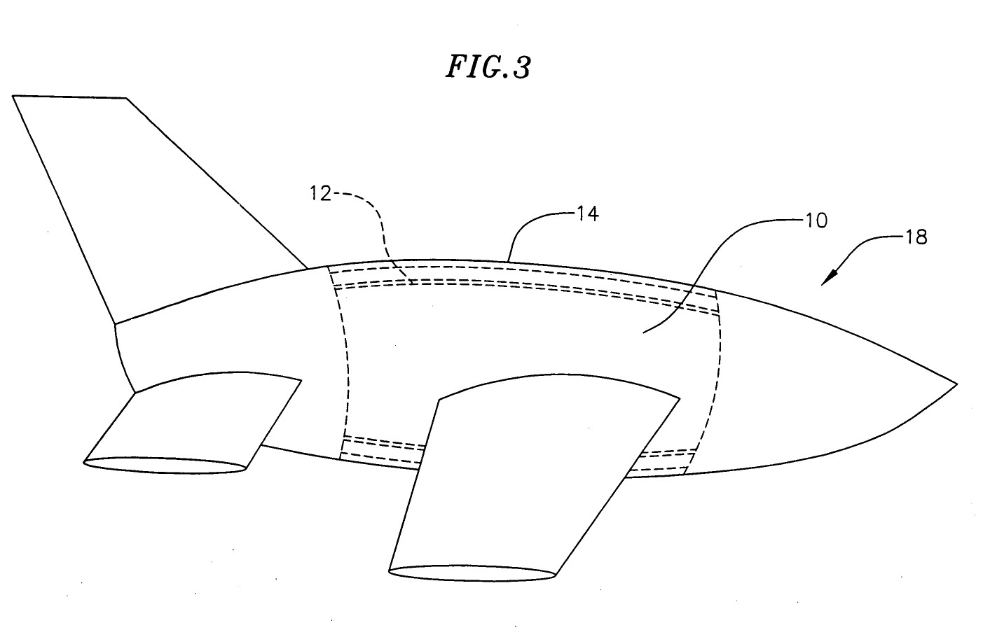

In one exemplary embodiment, because the outer wall remains relatively warm in relation to the temperatures of the cryogenic fluids being carried, the cryogenic tank of the present invention also forms part of a vehicle structure 18, such as an aerospace vehicle structure as for example shown in FIG. 3, or other vehicle structures such as missiles and expendable launch vehicle structures. In this exemplary embodiment the outer wall of the tank forms an outer surface portion of the vehicle structure. Using the tank as part of the overall vehicle structure offers a substantial reduction in vehicle weight. Tanks of the present invention may also be rigidly connected to a vehicle structure.

In an exemplary embodiment, the inner wall 12 of the tank is made from a material which has a low coefficient of thermal expansion (“CTE”). Moreover, the inner wall is made from a material that is resistant to the chemical and cryogenic properties of the fluid it stores.

In an exemplary embodiment, the CTE of the inner wall is sufficiently low such that over the service range of temperatures that the tank inner wall is exposed to, the amount that the inner wall shrinks will be smaller than the allowable strain of the insulating material core and of a cryogenic adhesive used to bond the inner wall to the core. The thicker the insulating core, the more inner wall shrinkage that is acceptable, i.e., the greater the inner wall CTE that is acceptable. The smaller the temperature range the tank inner wall is exposed to, the greater the inner wall coefficient of thermal expansion that is acceptable. In other exemplary embodiments, the inner wall CTE over its operating temperature range is not greater than 12 parts per million of length per degree Kelvin (12 ppm/° K.).

In one exemplary embodiment, material making up the core should be sufficiently stiff in shear to transmit stresses between the inner and outer walls. An exemplary material forming the core is one that is rigid and a good insulator, such as a rigid polymer foam, as for example a Rohacell foam such as a Rohacell 51.8 foam, or a foam-filled honeycomb. In an exemplary embodiment, although rigid, the core has a modulus of elasticity that is lower than the modulus of elasticity of the inner wall and/or the outer wall. The insulating rigid core material also serves to stabilize the inner and outer walls against buckling. This is especially important for tanks in aerospace vehicles which are typically low pressure tanks with wall thicknesses limited by fabrication techniques.

If built from a single wall construction, conventional tanks are fragile and offer little structural support to the vehicle. The sandwich construction tanks of the present invention support substantial vehicle loads, and also resist local loads from ground handling. Therefore, in addition to reducing the weight of vehicles, such as aerospace vehicles, the present invention when incorporated as part of the vehicle structure, makes the vehicle more rugged and damage resistant.

In one exemplary embodiment, the inner wall 12 is fabricated from a glass fiber reinforced fluoropolymer which retains flexibility at cryogenic temperatures and which is nonflammable and chemically compatible with liquid oxygen. Exemplary fluoropolymers include DuPont's PTFE 30 or PTFE 30B aqueous dispersion fluoropolymers. Other exemplary fluoropolymers include polytetrafluoroethylene (“PTFE”), polychlorotrifluoroethylene (“PCTFE” or “Kel-R”) and perfluoroalkoxy (“PFA”). Exemplary fibers used to form the inner wall include Saint-Gobain R-Glass fibers, Advanced Materials S-2 glass fibers, Saint-Gobain fused silica Quartzel fibers and BFG Industries Greige fiber. Exemplary glass fiber reinforced fluoropolymers have a CTE in the range of about 0.5 ppm/° K. to about 4 ppm/° K.

A glass fiber reinforced fluoropolymer inner wall has been discovered by the applicants to be a suitable material for carrying hydrogen peroxide oxidizer which is typically used in space vehicles. Hydrogen peroxide is non-cryogenic, but is chemically incompatible with many tank materials. Consequently, an exemplary embodiment tank of the present invention may also be used to store non-cryogenic fluids such as hydrogen peroxide.

An adhesive 20 is used to bond the inner wall 12 to the core 16. The properties of the adhesive may be critical to the function of the tank. Since it is impractical to select an adhesive with a CTE as low as the tank inner wall, some strain may develop between the adhesive and the inner wall. In the exemplary embodiment, the adhesive should remain flexible at the operating temperature of the tank contents, so that the stresses at the adhesive interface with the inner wall remain acceptably low, as for example at a level of about 250 psi or lower. In an exemplary embodiment, the adhesive should have a maximum elongation at the tank operating temperature (i.e., the temperature of the fluid being carried) of at least 1%. An exemplary adhesive is a cryogen-compatible urethane adhesive.

The adhesive 20 can also serve to further reduce the permeability of the tank inner wall by acting as a sealant. Unlike tanks employing a liner as a sealant, with the exemplary embodiment tank, the sealant, i.e., the adhesive, is outside the tank inner wall, yet held firmly against the tank inner wall by the insulating core and the tank outer wall. In this regard, the sealing function of the inner wall adhesive is protected against scratches or wear from within the tank by the inner wall and from the outside of the tank by insulating core and the outer wall.

An outer wall adhesive 22 can be used to bond the insulating core to the outer wall. Since the outer wall does not see extreme temperature cycling, the outer wall adhesive 22 may be more conventional.

In one exemplary embodiment, a tank of the present invention is formed over a mandrel. Specifically, a sacrificial mandrel is used which can be washed out of the tank. An initial thin layer of fluoropolymer resin is brushed or otherwise applied on the mandrel. Acceptable resins include but are not limited to DuPont PTFE 30 or PTFE 30B aqueous dispersion resins, as well as PTFE. Glass-fiber yarn or fibers, as for example Saint-Gobain R-Glass, Advanced Materials S-2 glass, Saint-Gobain fused silica Quartzel, or BFG Industries Greige fiber yarn or fibers are pre-impregnated with the fluoropolymer resin. In preparing the pre-impregnated yarn, it is important that the yarn or fiber used has a suitable surface for adhering to the resin. The fiber surface can be prepared for adhering to the resin by removing the sizing on the fiber prior to impregnating the fiber with the resin and drying. The technique for removal of the sizing depends on the sizing applied. For example, “gray” fiber, such BFG Industries Greige fiber, uses an oil and starch sizing which can be removed by washing with suitable solvents, while fiber with an epoxy-compatible sizing has to be heated in an oxidizing atmosphere to remove the sizing. After the pre-impregnation process, the yarn or fiber is dried. Several plies of pre-impregnated yarn or fiber are wound over the mandrel coated with resin. Alternatively, the plies may be hand laid using well known techniques. Additional wet resin may be applied if needed to achieve proper resin content. The entire assembly is dried.

The fluoropolymer resin is a thermoplastic type of resin and consolidates when subjected to heat and pressure to form the structural inner wall. A vacuum may be applied to the laid fluoropolymer resin impregnated fibers or yarn by covering the mandrel and surrounding fluoropolymer resin impregnated fibers or yarn with a vacuum bag. A vacuum is pulled inside the bag, and the entire assembly is consolidated in an oven. If additional pressure is needed, an autoclave may be used. Alternatively, a close-fitting outer shell tool which is known in the art, may be used with a layer of silicone rubber between the outer shell tool and the inner wall. The outer shell tool acts as a clamp preventing expansion of the object which it surrounds, i.e., the laid inner wall. As the assembly with the outer shell tool is heated in the oven, the silicone rubber expands and provides pressure against the fluoropolymer resin impregnated fibers, i.e., the inner wall, during curing in the oven.

The resulting inner wall outer surface is then treated to promote adhesive bonding. The treatment should be done in accordance with the resin manufacturer's directions if such directions are provided. This may involve plasma etching or chemical etching of the inner wall outer surface.

Pieces of structural insulation having low thermal conductivity such as Rohacell, a polymethacrylimide or other polymer foam are bonded together and then shaped by a combination of thermo-forming and machining or other methods known in the art to a shape conforming to the inner wall of the tank. These pieces are bonded to the inner wall outer surface using a cryogenic adhesive such as for example, Cryobond-920 made by Composite Technologies Development, PR-1665 made by PRC deSoto International, 4538N made by Duralco, Foster 81-84 made by Specialty Construction Brands, Inc., EP29LPSP made by Master Bond Inc., or a cryogen-compatible urethane adhesive. In one exemplary embodiment, the pieces of structural insulation are also bonded to each other using the same adhesive. The adhesive between structural insulation pieces and/or between the pieces and the inner wall may contain microballoons such as 3M's S32 glass bubbles to increase viscosity and decrease thermal conductivity.

In an exemplary embodiment, the thermal conductivity of the structural insulation is not greater than 0.25 Watt/meter-° K. However, the thermal conductivity of the insulation should be selected for the application at hand, as different applications can tolerate different rates of thermal conductivity. Moreover, tanks subjected to high bending loads will require thicker walls, i.e., will require a thicker core between the inner and outer walls of the tank, for structural stiffness than tanks subjected to lower loads. The thicker core can tolerate higher thermal conductivity.

The adhesive with insulating material is cured to form the insulating layer. The outer surface of the insulating layer is coated with an outer wall adhesive. In an exemplary embodiment where the outer wall is formed from a fiber reinforced composite material, an adhesive, such as a resin of similar chemistry to the outer wall is used. For example, an MGS system 285 epoxy adhesive is used when the outer wall is to be formed from a fiber reinforced epoxy, or a Bryte Technologies EX 1515-1 cyanate ester resin adhesive is used when the outer wall is formed from a cyanate ester fiber reinforced system. The adhesive may include microballoons which increase the adhesive's viscosity.

While the adhesive is still wet, the outer wall is wound directly over the insulating core surface, using either a wet layup of a resin such as MGS system 285 or Bryte Technologies EX 1515-1 cyanate ester system with fibers such as Owens Coming S-2 glass fibers, Cytec T-650 or P-100 carbon fibers, other carbon fibers, glass such as E-glass fibers, Kevlar 49 aramid fiber s, or other aramid fibers, or using similar pre-impregnated tapes or other fiber/resin systems, as for example fiber reinforced cyanate ester systems. The selected system must have a cure temperature below the maximum service temperature of the insulating core. If Rohacell foam is used, than the system resin cure temperature must be below 266° F. which is the maximum service temperature of the Rohacell foam. The exterior wall is then cured. Instead of being wound, the outer wall may be hand laid using well known techniques.

In other exemplary embodiments, the outer wall may be formed from other materials such as metallic materials, as for example aluminum and its alloys or stainless steel. In one exemplary embodiment, the tank outer wall is formed as an integrated part of a vehicle's outer skin, and as such, the outer wall is formed from the same material as the material forming the outer skin of the vehicle or a material having sufficient capabilities for operating as the vehicle's outer skin.

In alternate exemplary embodiments, the inner wall may be formed from an iron-nickel alloy, as for example an Invar 36, Incoloy 903, Incoloy 909, or Nilo 36 alloy. An inner wall formed form such iron-nickel alloy in an exemplary embodiment has a CTE in the range of about 1.5 ppm/° K. to about 7.7 ppm/° K. An exemplary inner wall formed from an iron-nickel alloy may have a thickness as low as 0.008 inch.

The iron-nickel alloy inner wall in an exemplary embodiment is formed by resistance-welding or brazing sheets of iron-nickel alloy to form the cylindrical section of the tank. The tank domes, i.e., the end sections of the tank, are either formed from welded or brazed gores iron-nickel alloys or from flat sheet of iron-nickel alloy hydroformed into a dome, then welded or brazed on to the cylindrical section. In another exemplary embodiment, the iron-nickel alloy may be plasma sprayed or otherwise applied to a sacrificial mandrel which can be washed or melted out of the formed iron-nickel tank.

Once the iron-nickel inner wall is formed it is treated to promote adhesive bonding, and the build up of the rest of the tank proceeds as described herein for the fluoropolymer inner wall.

An exemplary embodiment tank of the present invention has a 72 inch inner diameter and an inner wall thickness in the range of about 0.05 to about 0.06 inch. The insulating core thickness is about 1 inch. The outer wall has a thickness of about 0.03 to about 0.04 inch. Such a tank will be able to safely carry liquid oxygen which is typically at 90° K. to space. In another exemplary embodiment the tank has a 24 inch inner diameter and an inner wall thickness of about 0.012 inch.

While the thickness of the inner wall may vary due to the dimensions of the tank and due to the task at hand, fiber reinforced fluoropolymer inner walls in an exemplary embodiment should have a minimum thickness in the range of about 0.015 inch to about 0.020 inch such that a sufficient thickness of material is available to close the pores between the fibers of the inner wall and prevent any leakage of the carried fluid through the inner wall. If the inner wall is made from an iron-nickel alloy than the thickness of the inner wall may be thinner as for example 0.008 inch, since iron-nickel is not permeable.

The thicknesses of the inner wall, the core and the outer wall are also a function of the relative CTEs of the inner wall, core and outer wall. For example, as the CTE of the inner wall is increased, the thickness of the core should also be increased.

The preceding merely illustrates the principles of the invention. It will thus be appreciated that those skilled in the art will be able to devise various arrangements which, although not explicitly described or shown herein, embody the principles of the invention and are included within the scope and spirit. Furthermore, all examples and conditional language recited herein are principally intended expressly to be only for pedagogical purposes and to aid in understanding the principles of the invention and the concepts contributed by the inventors to furthering the art, and are to be construed as being without limitation to such specifically recited examples and conditions. Moreover, all statements herein reciting principles, aspects, and embodiments of the invention, as well as specific examples thereof, are intended to encompass both structural and the functional equivalents thereof. Additionally, it is intended that such equivalents include both currently known equivalents and equivalents developed in the future, i.e., any elements developed that perform the same function, regardless of structure. The scope of the present invention, therefore, is not intended to be limited to the exemplary embodiments shown and described herein. Rather, the scope and spirit of the present invention is embodied by the appended claims.

What is claimed is:

1. A propelled vehicle for traveling through an environment, the vehicle comprising:
an outer wall exposed to the environment in which it is traveling;
an inner wall compatible with a cryogenic fluid; and
an insulating layer sandwiched between the two walls, wherein said inner and outer walls act together to define a rigid overall structural wall of a tank comprising said insulating layer for carrying the cryogenic fluid.

2. The vehicle as recited in claim 1 wherein the inner wall has a coefficient of thermal expansion no greater than about 12 ppm/° K.

3. The vehicle as recited in claim 2 wherein the inner wall comprises a reinforced fluoropolymer.

4. The vehicle as recited in claim 3 wherein the inner wall comprises a glass fiber reinforced fluoropolymer.

5. The vehicle as recited in claim 3 wherein the fluoropolymer is selected from the group of fluoropolymers consisting of polytetrafluoroethylene, polychlorotrifluoroethylene and perfluoroalkoxy.

6. The vehicle as recited in claim 1 wherein the inner wall comprises an iron-nickel alloy.

7. The vehicle as recited in claim 7 wherein said iron-nickel alloy is selected from the group of iron nickel alloys consisting of Invar 36, Incoloy 903, Incoloy 909 and Nilo 36.

8. The vehicle as recited in claim 1 further comprising an adhesive bonding the inner wall to the insulating layer, wherein the adhesive is a flexible epoxy adhesive.

9. The vehicle as recited in claim 1 further comprising an adhesive bonding the inner wall to the insulating layer, wherein the adhesive is flexible having a maximum elongation at the tank operating temperatures of not less than about 1%.

10. The vehicle as recited in claim 1 further comprising an adhesive bonding the inner wall to the insulating layer, wherein the adhesive includes microballoons.

11. The vehicle as recited in claim 1 further comprising an adhesive bonding the inner wall to the insulating layer, wherein the adhesive forms a sealing layer against the cryogenic fluid being carried by the tank.

12. The vehicle as recited in claim 1 further comprising an adhesive bonding the inner wall to the insulating layer, wherein the adhesive is a cryogen-compatible urethane adhesive

13. The vehicle as recited in claim 1 wherein the insulating layer has a modulus of elasticity lower than a modulus of elasticity of the inner wall.

14. The vehicle as recited in claim 13 wherein the insulating layer has a modulus of elasticity lower than a modulus of elasticity of the outer wall.

15. The vehicle as recited in claim 1 wherein the insulating layer has a thermal conductivity no greater than about 0.25 Watt/meter-° K.

16. The vehicle as recited in claim 1 wherein the insulating layer comprises a foamed polymer.

17. The vehicle as recited in claim 16 wherein the foam polymer comprises polymethacrylimide.

18. The vehicle as recited in claim 1 wherein the insulating layer comprises a foam filled honeycomb structure.

19. The vehicle as recited in claim 1 wherein the outer wall is a fiber reinforced structure.

20. The vehicle as recited in claim 19 wherein the outer wall comprises fibers selected from the group consisting of glass, carbon and aramid fibers.

21. The vehicle as recited in claim 1 wherein the outer wall is formed from a metallic material.

22. The vehicle as recited in claim 1 further comprising an adhesive bonding the outer wall to the insulating layer, wherein the outer wall comprises a fiber-reinforced cyanate ester resin and wherein said adhesive comprises cyanate ester resin and glass microballoons.

23. The vehicle as recited in claim 1 wherein said wall defines part of an outer structure of a flying vehicle.

24. The vehicle as recited in claim 23 wherein said structure is a fuselage.

25. The vehicle as recited in claim 1 further comprising a cryogenic fluid within the tank.

26. The vehicle as recited in claim 1 further comprising a fluid within the tank, said fluid selected from the group of fluids consisting of liquid oxygen, hydrogen peroxide, liquid hydrogen, liquid methane and nitrous oxide.

27. The vehicle as recited in claim 1 wherein the inner wall is chemically compatible with hydrogen peroxide.
